(19) United States
(12) Patent Application Publication
(10) Pub. No.: US 2025/0269439 A1
(43) Pub. Date: Aug. 28, 2025

(54) Nested Hole Saw Set with Quick Connect Arbor and Tube Storage Case

(71) Applicant: Klein Tools, Inc., Lincolnshire, IL (US)

(72) Inventors: Juan Sebastian Caro, Fort Worth, TX (US); Jonathan Low, Fort Worth, TX (US); James E. Murphy, Bartonville, TX (US); Grace A. Conway, Dallas, TX (US); Kingston Wong, Mansfield, TX (US)

(73) Assignee: Klein Tools, Inc., Lincolnshire, IL (US)

(21) Appl. No.: 19/067,813

(22) Filed: Feb. 28, 2025

Related U.S. Application Data
(60) Provisional application No. 63/558,927, filed on Feb. 28, 2024.

(51) Int. Cl. B23B 51/04

(52) U.S. Cl. CPC B23B 51/0473

(57) ABSTRACT

A hole saw system includes a first hole saw, a second hole saw, and an arbor. The first hole saw is capable of being nested within the second hole saw. Each of the hole saws includes a mount wall having a first engagement feature configured to receive a first drive feature and a second engagement feature configured to receive a second drive feature that is different from the first drive feature. The arbor includes the first drive feature and the second drive feature and is configured to selectively mount each of the hole saws in a single saw arrangement and to selectively mount both of the hole saws in a nested saw arrangement. In the single saw arrangement, the arbor mounts a single one of the hole saws with the first drive feature engaged in the first engagement feature and the second drive feature not engaged with the second engagement feature. In the nested saw arrangement, the arbor mounts both of the hole saws with the first hole saw nested within the second hole saw and the first drive feature engaged in the first engagement feature of the first hole saw and the second drive feature engaged in the second engagement feature of the second hole saw.

### CROSS-REFERENCE TO RELATED APPLICATIONS

This application claims priority to provisional U.S. Patent Application No. 63/558,927 filed Feb. 28, 2024, the entire disclosure of which is incorporated herein by reference.

### BACKGROUND OF THE DISCLOSURE

The present disclosure relates to tools, and more particularly, to a cup-shaped hole saws that are mounted on an arbor or mandrel for cutting circular holes through a work piece, such a door, wall, floor, or stud, and more specifically to such tools wherein a cup-shaped hole saw can be quickly and easily removed from and installed onto an arbor. While such tools are known and work well for their intended purpose, there is always room for improvement.

### BRIEF SUMMARY OF THE DISCLOSURE

In accordance with one aspect of this disclosure, a hole saw system is provided and includes a first hole saw, a second hole saw, and an arbor. The first hole saw is capable of being nested within the second hole saw. Each of the hole saws is sized to cut a different diameter hole than the other hole saw. Each of the hole saws has a cylindrical shaped cutting wall extending upward from a mount wall, with the mount wall including a first engagement feature configured to receive a first drive feature and a second engagement feature configured to receive a second drive feature that is different from the first drive feature. The arbor includes the first drive feature and the second drive feature and is configured to selectively mount each of the hole saws in a single saw arrangement to perform a single hole cut and to selectively mount both of the hole saws in a nested saw arrangement with the first hole saw nested within the second hole saw to perform a double hole cut. In the single saw arrangement, the arbor mounts a single one of the hole saws with the first drive feature engaged in the first engagement feature and the second drive feature not engaged with the second engagement feature. In the nested saw arrangement, the arbor mounts both of the hole saws with the first hole saw nested within the second hole saw and the first drive feature engaged in the first engagement feature of the first hole saw and the second drive feature engaged in the second engagement feature of the second hole saw.

As one aspect, the mount wall of each of the hole saws includes a plurality of the first engagement feature and a plurality of second engagement features, with the first engagement features being equally circumferentially spaced from each other and the second engagement features being equally circumferentially spaced from each other.

In one aspect, the first drive feature extends above the second drive feature.

According to one aspect, the first drive feature is a pin and each of the first engagement features is a bore extending into the mount wall and shaped to receive the pin. In a further aspect the pin is a cylindrical shaped pin and the bore is shaped to conform to the cylindrical shape of the pin.

As one aspect, the second drive feature is defined by at least one rib and each of the second engagement features is an opening in the mount wall shaped to receive the at least one rib. In a further aspect, the at least one rib defines an upwardly facing surface that engages against a downwardly facing surface of the mount wall of each of the hole saws with the first drive feature engage in the first engagement feature of the mount wall. As another aspect, the at least one rib extends from the pin, and the opening in each of the mount walls is shaped to receive the pin. In a further aspect, the at least one rib is two ribs extending from opposite sides of the pin.

According to one aspect, each of the hole saws include an additional first engagement feature and an additional second engagement feature, and the arbor includes an additional first drive feature and an additional second drive feature.

In one aspect, the arbor further includes a locking member that engages each of the hole saws to retain the hole saw on the arbor with the first drive feature engaged in the first engagement feature of the hole saw.

According to one aspect, the locking member defines a shoulder that engages against a surface of the mount wall of each of the hole saws to retain the hole saw on the arbor with the first drive feature engaged in the first engagement feature of the hole saw.

As one aspect, the locking member is mounted to the arbor to move between a loading position wherein each of the hole saws can be loaded onto the arbor to engage the first drive feature in the first engagement feature and a locking position wherein the locking member engages the hole saw to retain the hole saw on the arbor with the first drive feature engaged in the first engagement feature.

According to one aspect, the arbor further includes an actuator that can be operated by a user to move the locking member from the locking position to the loading position.

As one aspect, the arbor includes an additional locking member that engages each of the hole saws to retain the hole saw on the arbor with the first drive feature engaged in the first engagement feature of the hole saw, the locking members being located opposite of each other on the arbor.

In one aspect, the hole saw system further includes a third hole saw that can be nested within the first hole saw, the third hole saw having a cylindrical shaped cutting wall extending upward from a mount wall.

According to one aspect, the third hole saw includes a third engagement feature formed in the cylindrical cutting wall of the first hole saw, the third engagement feature shaped to receive a drive portion of the locking member.

As one aspect, the cylindrical cutting wall of the third hole saw is spaced radially inward from the second drive feature with drive portion of the locking member engaged in the third engagement feature.

In one aspect, the mount wall of at least one of the first and second hole saws have a central opening sized to allow the cylindrical cutting wall of the third hole saw to pass through the mounting wall to allow the third hole saw to be mounted on the arbor nested within the at least one of the first and second hole saws.

### BRIEF SUMMARY OF THE SEVERAL VIEWS OF THE DRAWINGS

FIG. 1 perspective view from above of a hole saw system according to this disclosure;

FIG. 2 is perspective view from above of a hole saw of the system of FIG. 1;

FIG. 3 is view similar to FIG. 1 but showing the system with the hole saw of FIG. 2 removed;

FIG. 4 is a perspective view from above of an arbor of the system of FIG. 1;

FIG. 5 is a view similar to FIG. 1, but showing the system in a single saw arrangement with a single hole saw mounted on the arbor;

FIG. 6 is a section view taken along line 6-6 in FIG. 5;

FIG. 7 is a broken section view taken along line 7-7 in FIG. 5;

FIG. 8 is a view similar to FIG. 5, but taken from a different angular orientation;

FIG. 9 is a top view of the system of FIG. 1;

FIG. 10 is a perspective from above of the system of FIG. 1;

FIG. 11 is a section view taken along line 11-11 in FIG. 9;

FIG. 12 is another perspective view from above of the system of FIG. 1;

FIG. 13 is a section perspective view taken from line 13-13 in FIG. 12;

FIG. 14 is a somewhat diagrammatic longitudinal cross section of the arbor of FIG. 4, showing locking members of the arbor in an unlocked or loading position;

FIG. 15 is similar to FIG. 14 but showing the locking members in a locking position;

FIG. 16 is a perspective view of the arbor of FIGS. 4, 15, and 16 with another size of hole saw mounted thereon;

FIG. 17 is a section view taken from line 17-17 in FIG. 16;

FIG. 18 is a top view of the hole saw of FIGS. 16 and 17 mounted in a nested saw arrangement on the arbor with one of the hole saws of FIG. 1;

FIG. 19 is a section perspective view taken from line 19-19 in FIG. 18;

FIG. 20 is a perspective view from above of the arbor of FIG. 4 with yet another size of hole saw carried thereon;

FIG. 21 is a longitudinal cross section of the arbor of FIG. 4 with the hole saw of FIG. 20 mounted in a nested saw arrangement on the arbor with one of the hole saws of FIG. 1;

FIG. 24 is a side elevation view of a storage case for the hole saw system according to this disclosure, with the hole saw system storage mounted therein and some of the case components formed from transparent material,

FIG. 25 is a view similar to FIG. 24 but showing the system 10 stored in a different configuration within the storage case of FIG. 24;

FIG. 22 is another embodiment of the storage case according to this disclosure wherein all of the case components are formed from non-transparent materials;

FIG. 23 is a longitudinal cross section of the storage case of FIG. 22 showing the hole saw system storage mounted therein;

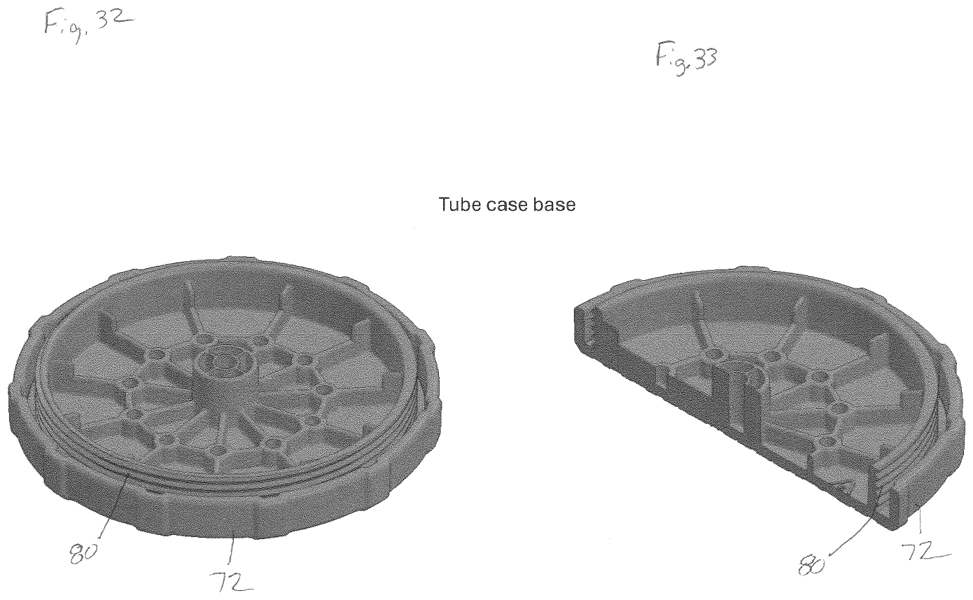

FIG. 26 is an exploded view of the storage case of FIGS. 24 and 25, with the hole saw system stored in the configuration shown in FIG. 24;

FIG. 27 is a view similar to FIG. 26 but with the hole saw system removed;

FIG. 28 is a perspective view from above of a top case member of the storage case according to this disclosure;

FIG. 29 is a section perspective view of the top case member of FIG. 28;

FIG. 30 is a perspective view from above of a center case member of the storage case according to this disclosure;

FIG. 31 is a section perspective view of the center case member of FIG. 30;

FIG. 32 is a perspective view from above of a base member of the storage case according to this disclosure; and

FIG. 33 is a section perspective view of the base member of FIG. 32.

### DETAILED DESCRIPTION OF PREFERRED EMBODIMENTS

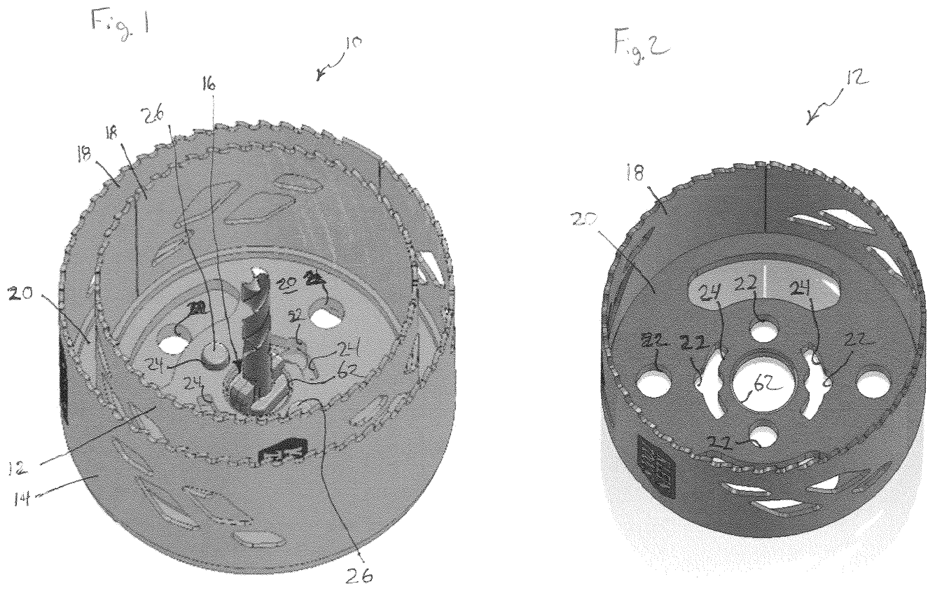

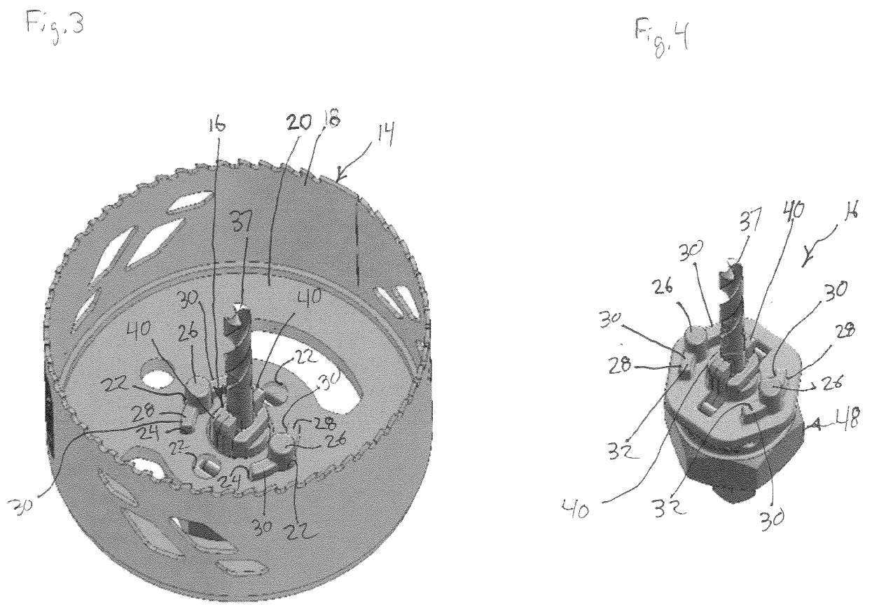

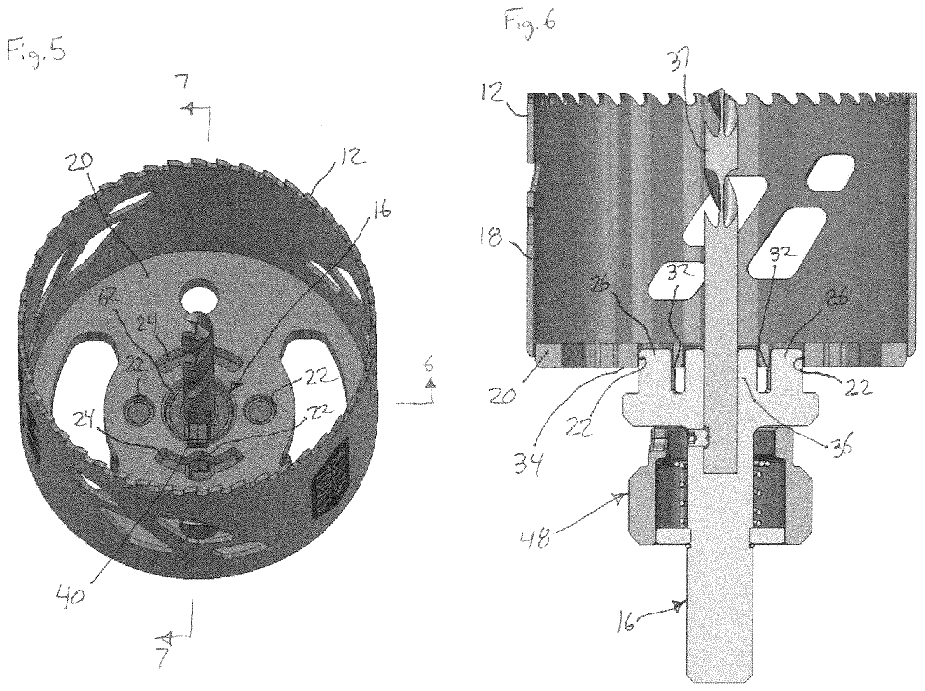

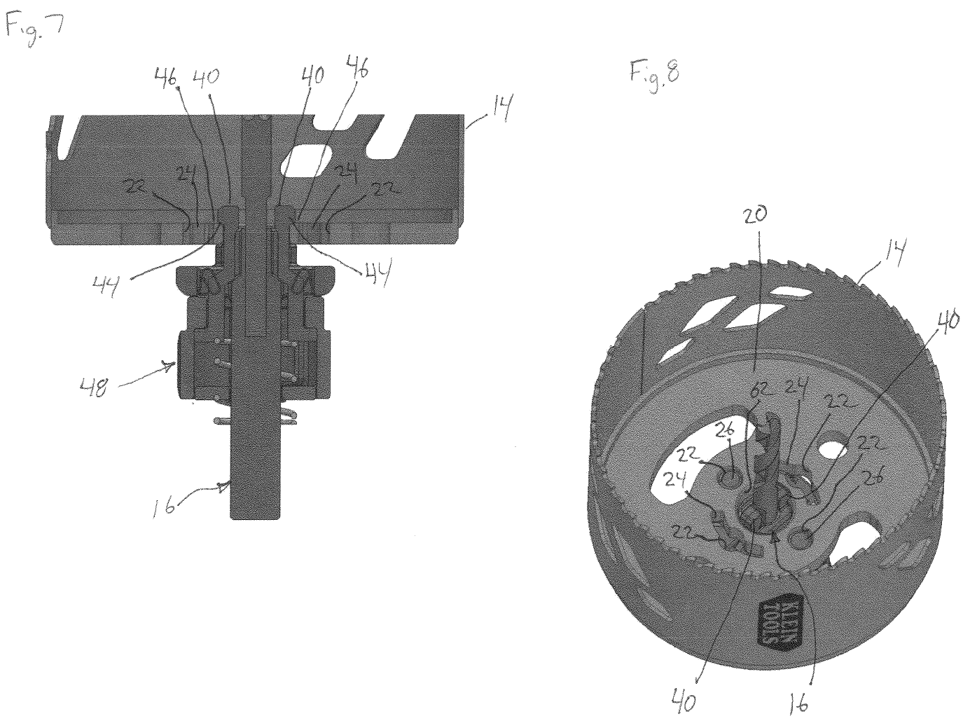

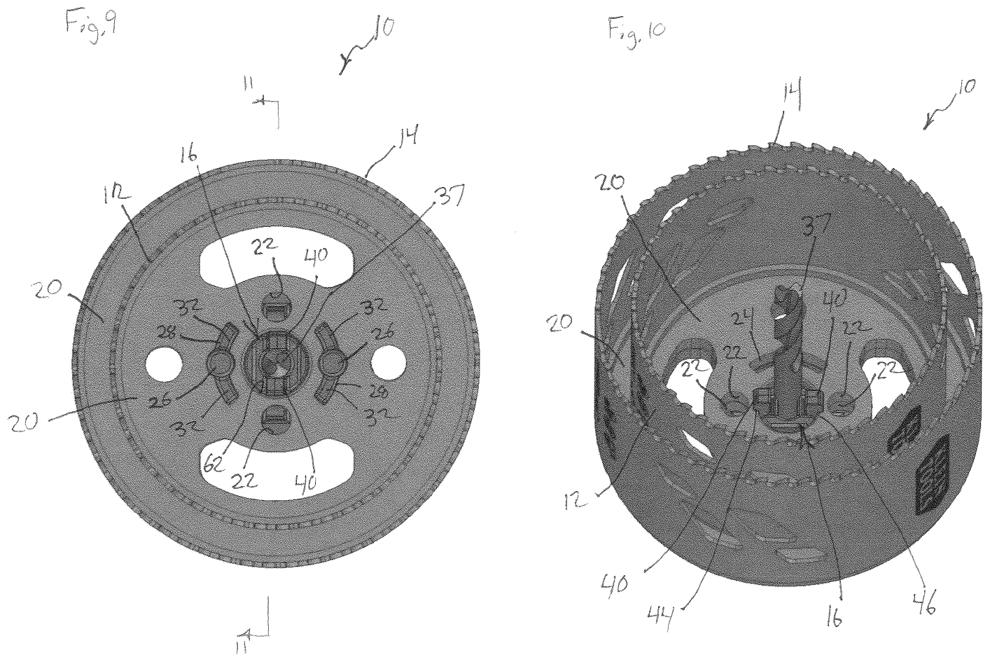

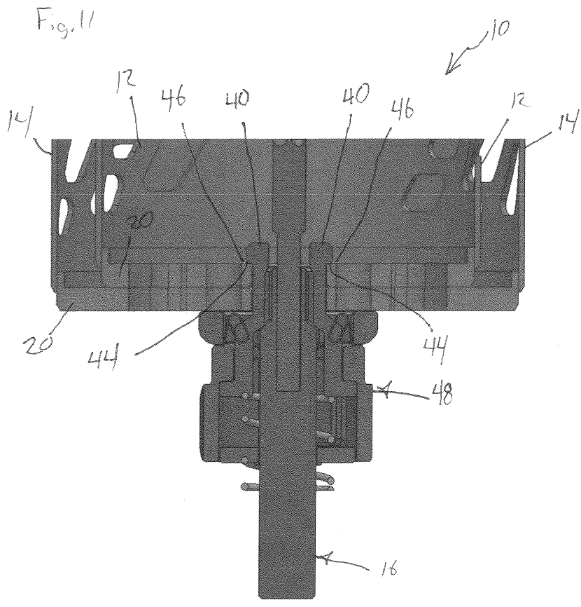

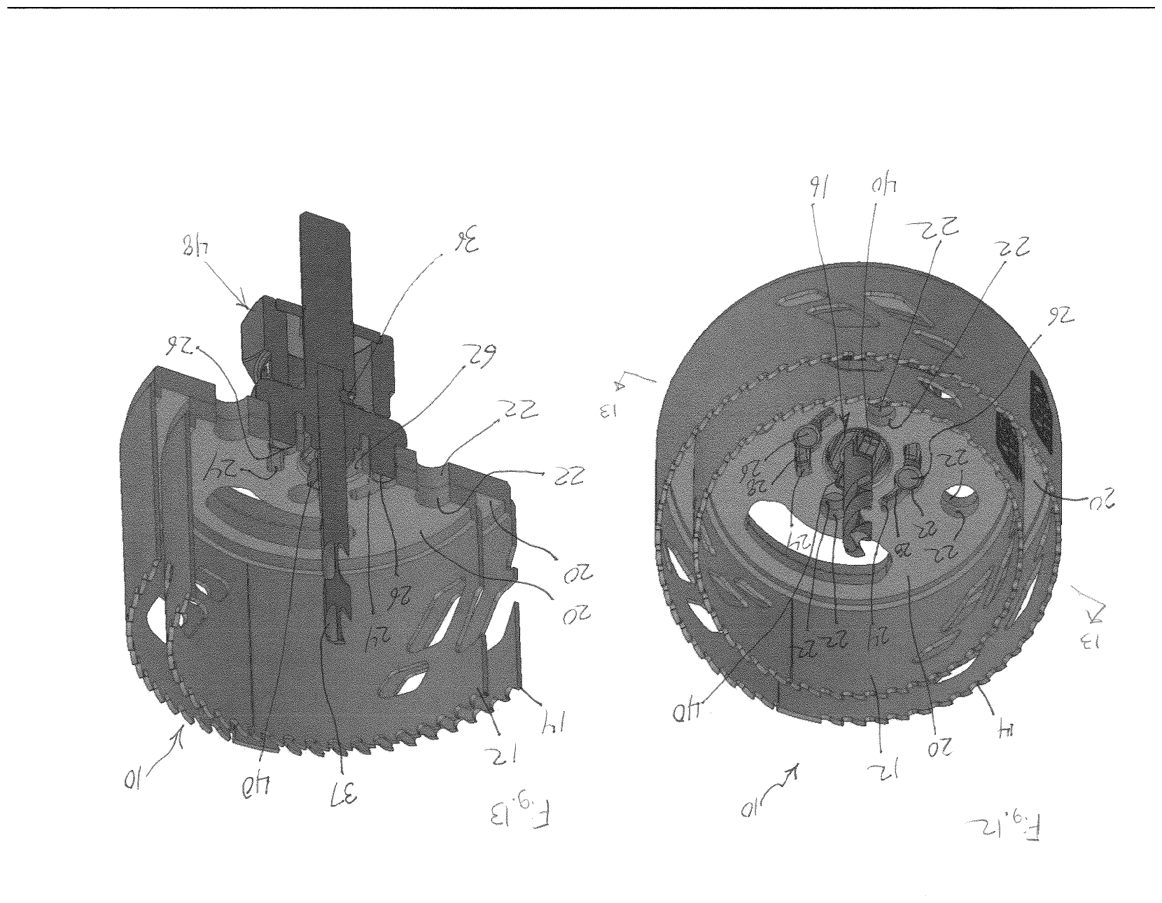

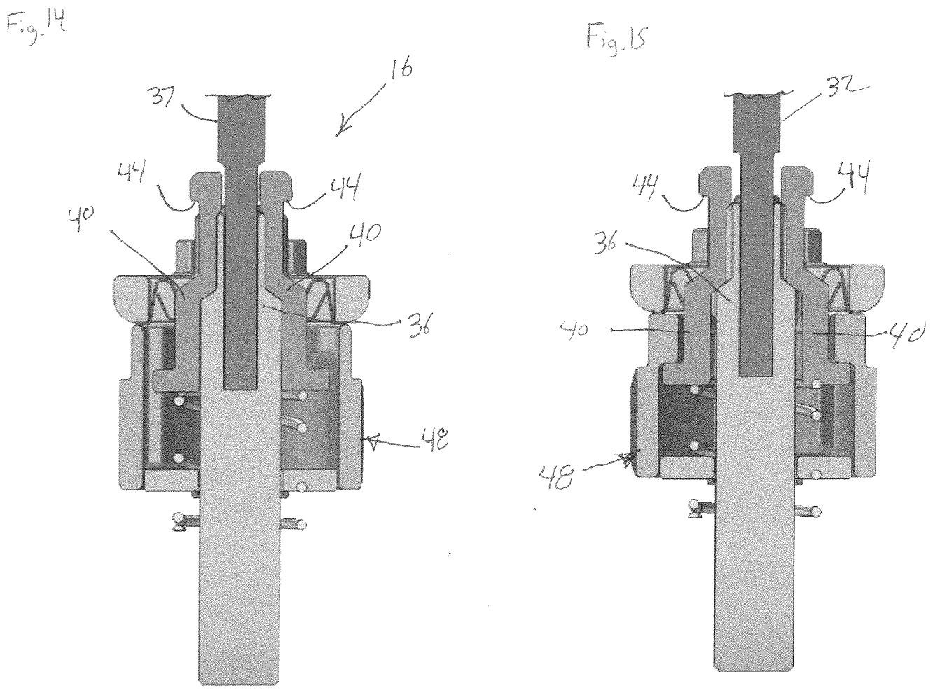

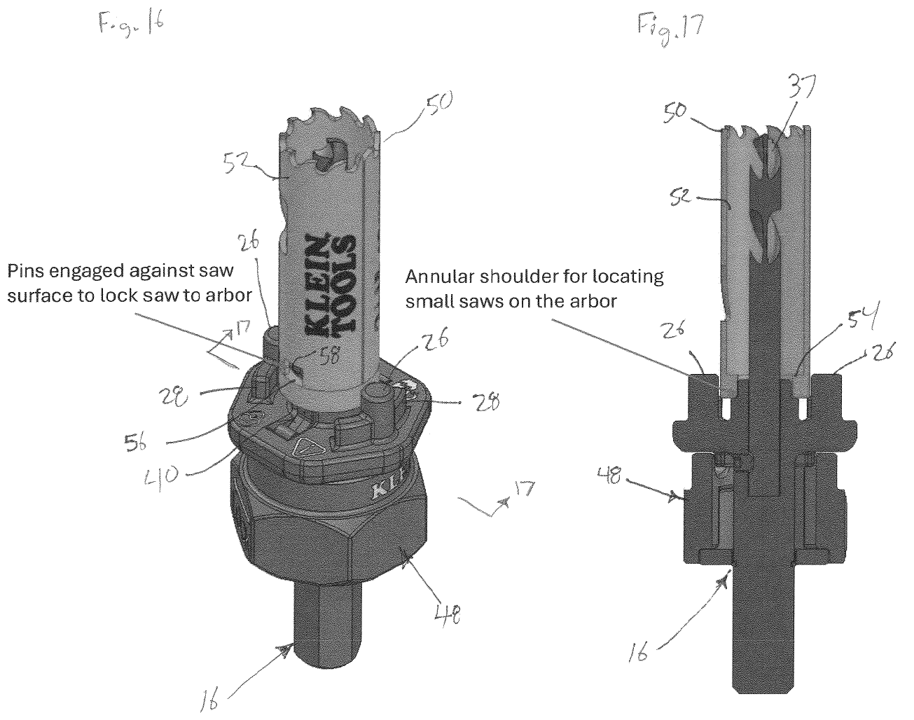

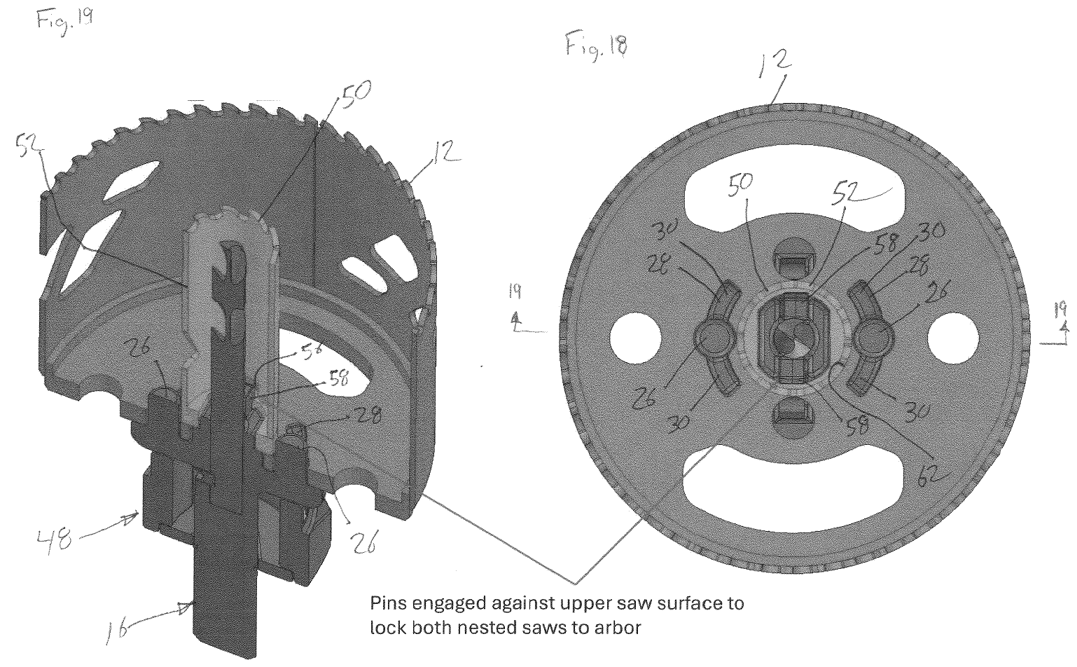

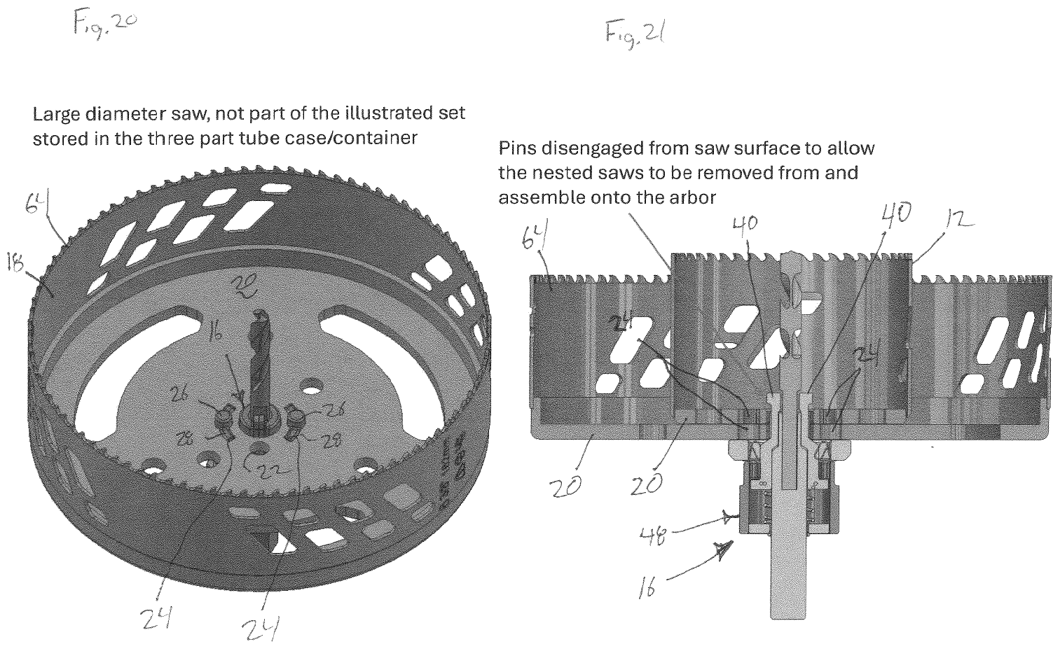

With reference to FIG. 1, a hole saw system 10 is shown and includes a first hole saw 12, a second hole saw 14, and an arbor 16. As shown, the first hole saw 12 is capable of being nested within the second hole saw 14, with each of the hole saws 12 and 14 being sized to cut a different diameter hole. Each of the hole saws 12 and 14 includes a cylindrical shaped cutting wall 18 extending upward from a mount wall 20. In the illustrated embodiments, each of the mount walls 20 includes a first pair of first engagement features 22 and a pair of second engagement features 24, as best seen in FIG. 2 and FIG. 3. In the illustrated embodiment, each of the mount walls 20 further includes a second pair of first engagement features 22, each associated with one of the second engagement features 24. As best seen in FIG. 4, in the illustrated embodiments, the arbor 16 includes a pair of first drive features 26 and a pair of second drive features 28. As best seen in FIGS. 1 and 2, each of the first engagement features 22 is configured to receive one of the first drive features 26 and each of the second engagement features 24 is configured to receive one of the second drive features 28.

As best seen in FIGS. 5-8, the arbor 16 is configured to selectively mount each of the hole saws 12 and 14 in a single saw arrangement to perform a single hole cut. In the single saw arrangement, the arbor 16 mounts a single one of the hole saws 12 and 14 with the first drive features 26 engaged in a pair of the first engagement features 22 and the second drive features 28 not engaged with the second engagement features 24. As best seen in FIGS. 1, 3, 9, and 10, the arbor 16 is also configured to selectively mount both of the hole saws 12 and 14 in a nested saw arrangement, with the first hole saw 12 nested within the second hole saw 14 to perform a double hole cut. In the nested saw arrangement, the arbor 16 mounts the first hole saw 12 nested within the second hole saw 14, with the first drive feature 26 engaged in a pair of the first engagement feature 22 of the first hole saw 12 and the second drive feature 28 engaged in the second engagement feature 24 of the second hole saw 14 (best seen in FIG. 3).

In the orientation shown in the illustrated embodiments, the first drive features 26 extend above the second drive feature 28. In the illustrated embodiments, the first drive feature 26 is a cylindrical shaped pin 26 and each of the first engagement features 22 is a cylindrical shaped bore 22 extending through the mount wall 20 and sized to receive the pin 26. As best seen in FIG. 4, n the illustrated embodiment, each of the second drive features 28 is defined by at a pair of arch shaped ribs 30 extending from opposite sides of an associated one of the pins 26 and each of the second engagement features 24 is a through opening 24 in the mount wall shaped to conform to receive the ribs 30.

As best seen in FIG. 6, in at least some of the embodiments, each of the ribs 30 defines an upwardly facing surface 32 that abuts against a downwardly facing surface 34 of the mount wall 20 of each of the hole saws 12 and 14 with the first drive feature 26 engage in the first engagement feature 22 that are not associated with the second engagement features 24.

It should be appreciated that the arbor 16 includes mount structure 36 for drivingly mounting a drill bit 37, as is common for the arbors of many known hole saw systems.

As best seen in FIGS. 7 and 11, in the illustrated embodiment, the arbor 14 further includes a pair of locking members 40 that can selectively engage each of the hole saws 12 and 14 to retain the hole saw on the arbor 16 with the first drive features 26 engaged in a pair of the first engagement feature 22. In this regard, in the illustrated embodiment, each of the locking members 40 defines a shoulder 44 that engages against a surface 46 of the mount wall 20 of each of the hole saws 12 and 14 to retain the hole saw on the arbor 16 with the first drive features 26 engaged in a pair of the first engagement feature 22.

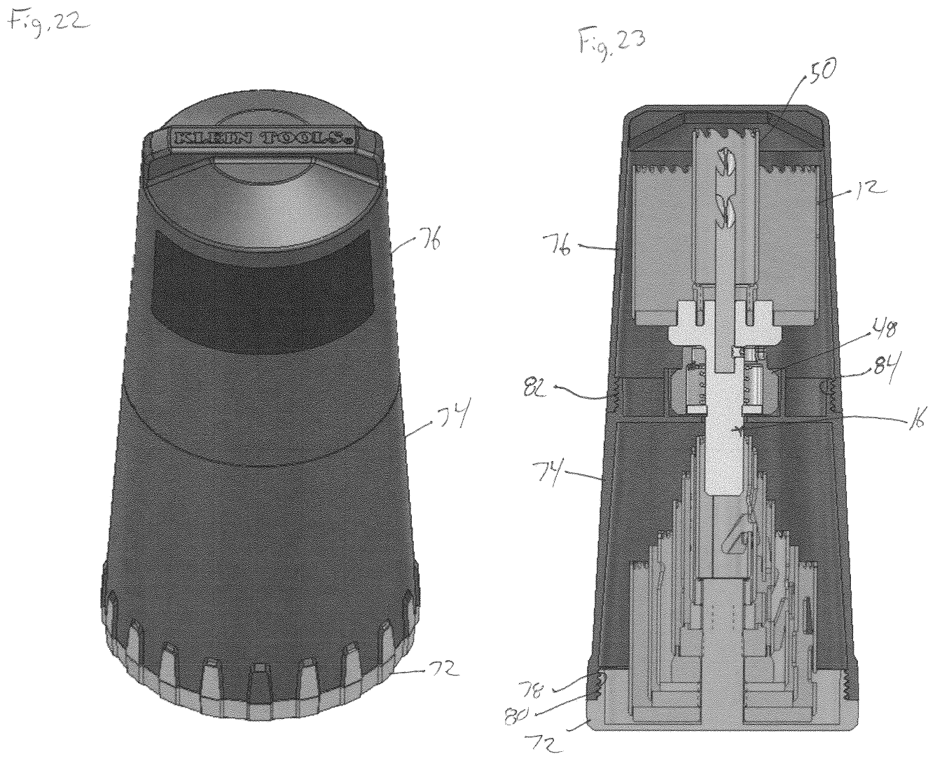

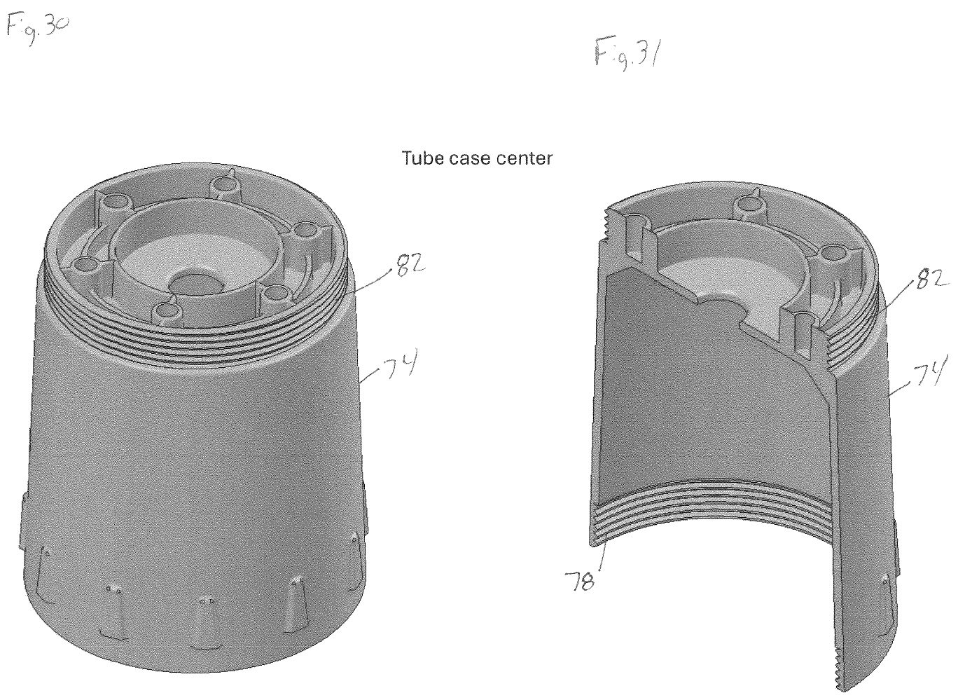

As best seen in FIGS. 14 and 15, each of the locking members 40 is mounted in the arbor 16 to move between an unlocked or loading position (shown in FIGS. 1, 3, 8, 9, 12-14, and 21) wherein each of the hole saws 12 and 14 can be loaded onto the arbor 16 to engage the first drive features 26 in a pair of the first engagement features 22, and a locking position (shown in FIGS. 5, 7, 10, 11, 15, 16, 18, and 19) wherein the locking members 40 engages the hole saw 12, 14 to retain the hole saw 12, 14 on the arbor 16 with the first drive features 26 engaged in a pair of the first engagement features 22. In the illustrated embodiment, the arbor 16 further includes an actuator unit 48 that can be operated by a user to move the locking members 40 from the locking position to the loading position. While preferred embodiments of the actuator unit 48 are shown in the Figs., it should be understood that any suitable mechanism for engaging and disengaging the locking members to lock and unlock hole saws to the arbor 16 can be utilized.

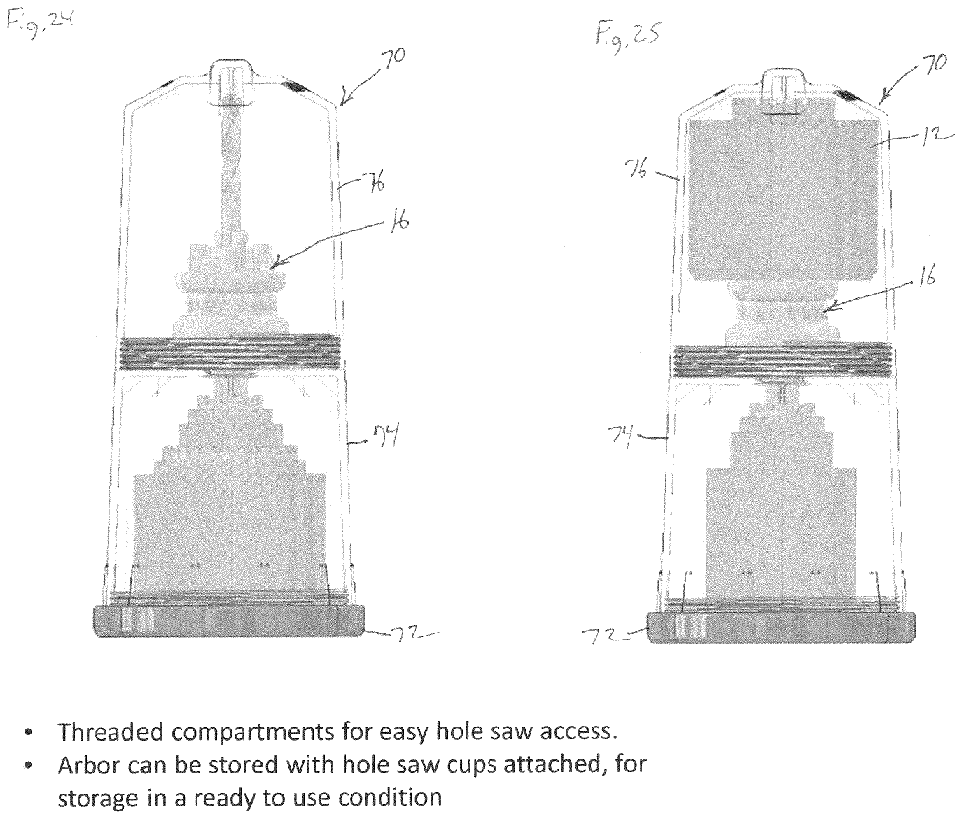

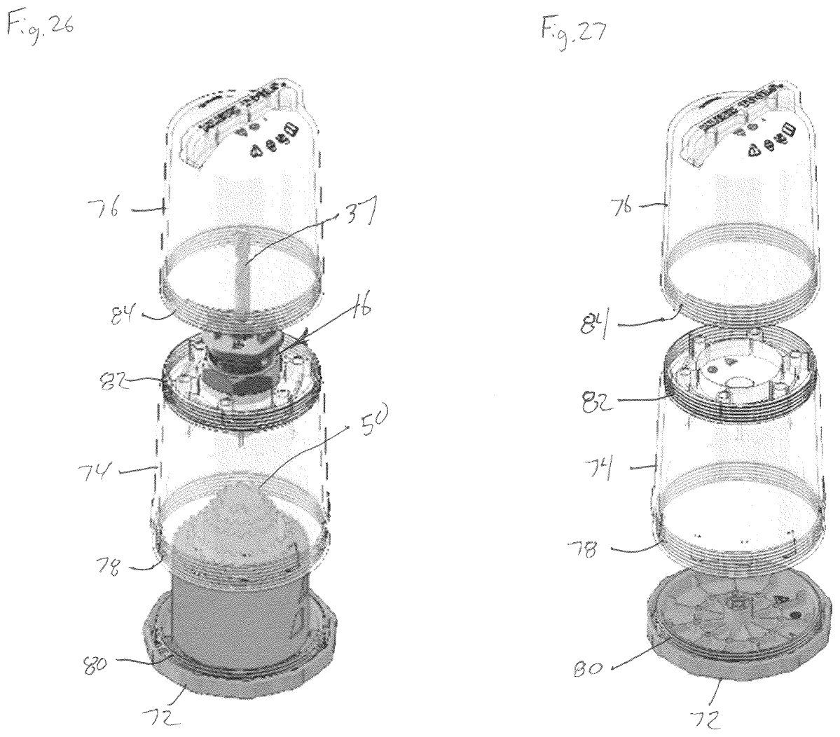

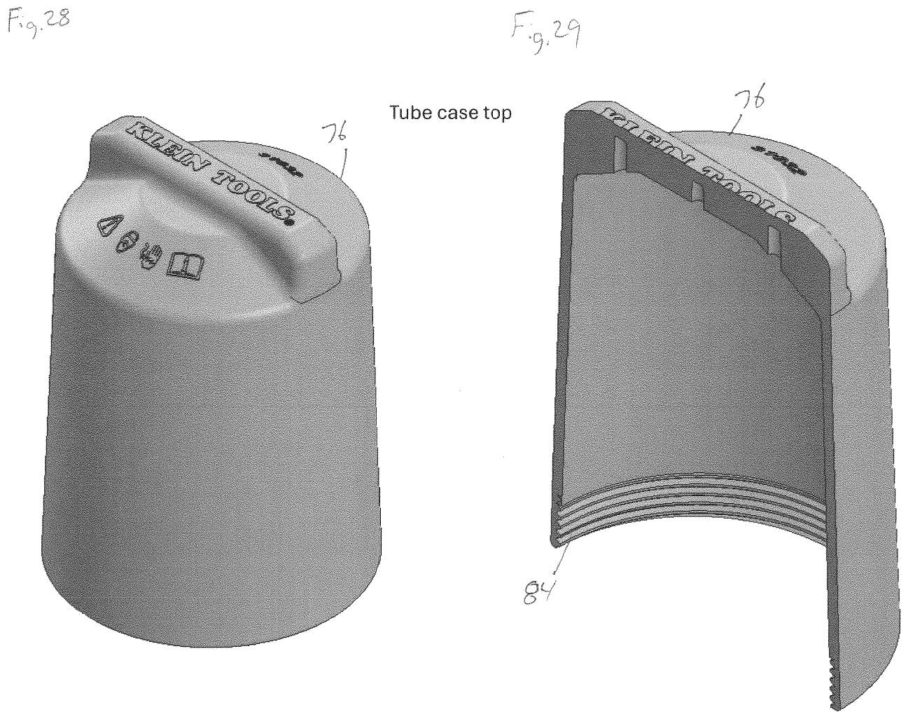

As best seen in FIGS. 16-19, in the illustrated embodiment, the system 10 includes a third hole saw 50 that can be nested within either the first hole saw 12 or the second hole saw 14. As with the other hole saws of the system, the third hole saw 50 has a cylindrical shaped cutting wall 52 extending upward from a mount wall 54. As can be seen in FIGS. 16-19, the third hole saw is configured to cut a much smaller diameter hole than the hole saws 12 and 14, and accordingly the cutting wall 52 is of a much smaller diameter. This smaller size will not allow for the third hole saw 50 to incorporate the first and second engagement features 22 and 24 of the other hole saws 12 and 14. Accordingly, the third hole saw 50 a pair of third engagement features 56 that are formed in the cylindrical cutting wall 52, with each of the features 56 being a recess 56 shaped to receive a drive portion 58 of a corresponding one of the locking members 40. As can be seen in FIGS. 16-19, when mounted on the arbor 16 with drive portions 58 engaged in the recesses 56, the cylindrical cutting wall 52 of the third hole saw 50 is spaced radially inward from the first and second drive features 24 and 26. As best seen in FIGS. 18 and 19, the mount wall 20 of each of the first and second hole saws 12 and 14 has a central through opening or bore 62 sized to allow the cylindrical cutting wall 52 to pass through the mounting wall 20 to allow the third hole saw 50 to be mounted on the arbor 16 nested within the either one of the first and second hole saws 12 and 14.

As shown in FIGS. 20, the system 10 can include hole saws of other sizes, such as the hole saw 64, that incorporate first and second engagement features 22 and 24 that are compatible with the first and second drive features 26 and 28 on the arbor 16 to allow further hole size options when the additional hole saws are mounted on the arbor in either the single saw arrangement or the nested saw arrangement. As best seen in FIGS. 23-26, the system can include a large number of such additional hole saws.

As shown in FIGS. 23-33, a tube-shaped storage case 70 can be included to store the system 10 and to allow for convenient use of the component of the system 10. As best seen in FIG. 27, in the illustrated embodiments, the case 70 includes a base 72, center case member 74, and a top case member 76. The center case member 74 includes screw threads 78 at its lower end to engage with mating screw threads 80 on the base 72 and further includes screw threads 82 at its upper end to engage with mating screw threads 84 in the lower end of the top case member 76. The base 72 is configured to carry a plurality of the hole saws 12, 14, 50, 64, etc. for storage. The Center case member 74 is configured to carry the arbor 16 with one or two of the hole saws 12, 14, 50, 64, etc. mounted on the arbor 16 in either the single saw or nested saw arrangements.

1. A hole saw system comprising:
a first hole saw and a second hole saw, the first hole saw capable of being nested within the second hole saw, each of the hole saws sized to cut a different diameter hole than the other hole saw, each of the hole saws having a cylindrical shaped cutting wall extending upward from a mount wall with the mount wall including a first engagement feature configured to receive a first drive feature and a second engagement feature configured to receive a second drive feature that is different from the first drive feature; and
an arbor comprising the first drive feature and the second drive feature and configured to selectively mount each of the hole saws in a single saw arrangement to perform a single hole cut and to selectively mount both of the hole saws in a nested saw arrangement with the first hole saw nested within the second hole saw to perform a double hole cut, wherein:
in the single saw arrangement, the arbor mounts a single one of the hole saws with the first drive feature engaged in the first engagement feature and the second drive feature not engaged with the second engagement feature, and
in the nested saw arrangement, the arbor mounts both of the hole saws with the first hole saw nested within the second hole saw and the first drive feature engaged in the first engagement feature of the first hole saw and the second drive feature engaged in the second engagement feature of the second hole saw.

2. The hole saw system of claim 1 wherein the mount wall of each of the hole saws includes a plurality of the first engagement feature and a plurality of second engagement features, with the first engagement features being equally circumferentially spaced from each other and the second engagement features being equally circumferentially spaced from each other.

3. The hole saw system of claim 1 wherein the first drive feature extends above the second drive feature.

4. The hole saw system of claim 1 wherein the first drive feature is a pin and each of the first engagement features is a bore extending into the mount wall and shaped to receive the pin.

5. The hole saw system of claim 4 wherein the pin is a cylindrical shaped pin and the bore is shaped to conform to the cylindrical shape of the pin.

6. The hole saw system of claim 4 wherein the second drive feature is defined by at least one rib and each of the second engagement features is an opening in the mount wall shaped to receive the at least one rib.

7. The hole saw system of claim 6 wherein the at least one rib defines an upwardly facing surface that engages against a downwardly facing surface of the mount wall of each of the hole saws with the first drive feature engage in the first engagement feature of the mount wall.

8. The hole saw system of claim 6 wherein the at least one rib extends from the pin, and the opening in each of the mount walls is shaped to receive the pin.

9. The hole saw system of claim 8 wherein the at least one rib is two ribs extending from opposite sides of the pin.

10. The hole saw system of claim 6 is the at least one rib is an arch shaped rib.

11. The hole saw system of claim 1 wherein each of the hole saws include an additional first engagement feature and an additional second engagement feature, and the arbor comprises an additional first drive feature and an additional second drive feature.

12. The hole saw system of claim 1 wherein the arbor further comprises a locking member that engages each of the hole saws to retain the hole saw on the arbor with the first drive feature engaged in the first engagement feature of the hole saw.

13. The hole saw system of claim 12 wherein the locking member defines a shoulder that engages against a surface of the mount wall of each of the hole saws to retain the hole saw on the arbor with the first drive feature engaged in the first engagement feature of the hole saw.

14. The hole saw system of claim 12 wherein the locking member is mounted to the arbor to move between a loading position wherein each of the hole saws can be loaded onto the arbor to engage the first drive feature in the first engagement feature and a locking position wherein the locking member engages the hole saw to retain the hole saw on the arbor with the first drive feature engaged in the first engagement feature.

15. The hole saw system of claim 14 wherein the arbor further comprising an actuator that can be operated by a user to move the locking member from the locking position to the loading position.

16. The hole saw system of claim 12 wherein the arbor comprises an additional locking member that engages each of the hole saws to retain the hole saw on the arbor with the first drive feature engaged in the first engagement feature of the hole saw, the locking members being located opposite of each other on the arbor.

17. The hole saw system of claim 12 further comprising a third hole saw that can be nested within the first hole saw, the third hole saw having a cylindrical shaped cutting wall extending upward from a mount wall.

18. The hole saw system of claim 17 a wherein the third hole saw comprises a third engagement feature formed in the cylindrical cutting wall of the first hole saw, the third engagement feature shaped to receive a drive portion of the locking member.

19. The hole saw system of claim 18 wherein the cylindrical cutting wall of the third hole saw is spaced radially inward from the second drive feature with drive portion of the locking member engaged in the third engagement feature.

20. The hole saw system of claim 19 wherein the mount wall of at least one of the first and second hole saws have a central opening sized to allow the cylindrical cutting wall of the third hole saw to pass through the mounting wall to allow the third hole saw to be mounted on the arbor nested within the at least one of the first and second hole saws.
